(19) United States
(12) Patent Application Publication
(10) Pub. No.: US 2011/0064856 A1
(43) Pub. Date: Mar. 17, 2011

(54) PROCESS TO OBTAIN A CRAB MEAT SUBSTITUTE FROM SHARK MEAT WHEREIN A PRODUCT IS OBTAINED HAVING QUALITY, TASTE, ODOR, COLOR AND APPEARANCE SIMILAR TO CRAB MEAT

(76) Inventor: Sergio Antonio Pérez Salinas, Coquimbo (CL)

(21) Appl. No.: 12/558,902

(22) Filed: Sep. 14, 2009

(51) Int. Cl. A23L 1/325; A23B 4/005; A23B 4/14; A23B 4/02; A23B 4/12

(52) U.S. Cl. 426/332; 426/643; 426/479; 426/442; 426/325

(57) ABSTRACT

A process for obtaining a crab meat substitute from shark—prionace glauca—meat wherein a product is obtained having quality, taste, odor, color and appearance similar to crab meat. It can use blue shark meat as raw material, which is a widely distributed shark around the world without restrictions. The raw material is freshly stored and shredded. It has a larger volume in the manufacturing process. It can be commercialized both preserved and frozen. The quality and final taste is almost identical to that of crab meat.

### FIELD OF INVENTION

The present invention relates to a crab substitute food product similar in color, texture, taste and odor to crab meat and a process to manufacture said food product.

Although the present invention relates to other crab substitute products, this invention is different both in the raw materials used and in the manufacture process. The final product is obtained from shark meat, preferably from blue shark (Prionace glauca), which is subjected to a several stages treatment to obtain a food product in which sensory characteristics of the raw material are minimized and said raw material is transformed into a product that is very similar to crab meat.

### BACKGROUND

In the past, there are precedents of invention patents related to the same field, but all of them have large differences when compared with the teachings of the present invention. Specifically:

U.S. Pat. No. 4,158,065 (“Crab meat substitute and method of preparing same”, Y. Sugino) describes a crab meat substitute product that is obtained from 3 to 8 centimeters fillets and the related coloring process with carotenoid pigments, annato coloring and food coloring Red No. 104.

U.S. Pat. No. 4,751,096 (“Fish product resembling crab meat”, M. Nada et al.), 5,141,766 (“Surimi”, M. Miyakawa), 5,275,832 and 5,240,723 (“Edible product of fish meat paste simulating crab leg meat”, Y. Sugino) only make reference to a crab substitute made from fish meat that do not comprise a chemical process, but only filleting or dehydrating.

U.S. Pat. No. 4,824,687 (“Process for manufacturing fabricated crab leg meat”, S. Yasuno), 5,176,932 (“Method of producing an edible product offish meat paste simulating crab”, Y. Sugino) and Korean Patent No. 20020072682 (“Production of imitation crabmeat product”, Chun Dong Hwan) only mention a process to obtain a crab substitute from fish meat that comprises only fish filleting in the first two patents and mixing with thermal treatment in the last one.

Lastly, the following patents also comprise a process to obtain a non-specified substitute from fish meat, with a different manufacturing method. Said patents are U.S. Pat. No. 5,006,353 (“Process for the production of surimi”, N. Nishi et al.), U.S. Pat. No. 4,181,749 (“Process for producing surimi”, H. Niki et al.), U.S. Pat. No. 4,579,741 (“Fabricated seafood”, M. Hanso et al.) and U.S. Pat. No. 5,223,301 (“Surimi manufacturing process”, K Kanda et al.), which describe a process to manufacture a substitute through dehydration, sun drying, immersion in water and filleting, respectively.

### SUMMARY

A process for obtaining a crab meat substitute from shark —prionace glauca—meat wherein a product is obtained having quality, taste, odor, color and appearance similar to crab meat.

In contrast to known processes and products, the subject matter of the present invention has the following technical advantages:
It uses preferably blue shark meat as raw material, which is a widely distributed shark around the world and do not have restrictions.
The raw material is freshly stored and shredded.
It has a larger volume in the manufacturing process.
It can be commercialized both preserved and frozen.
The quality and final taste is almost identical to that of crab meat.

### BRIEF DESCRIPTION OF DRAWINGS

FIG. 1 is a flow diagram of the process for obtaining crab meat substitute from shark meat according to the present development.

### DETAILED DESCRIPTION

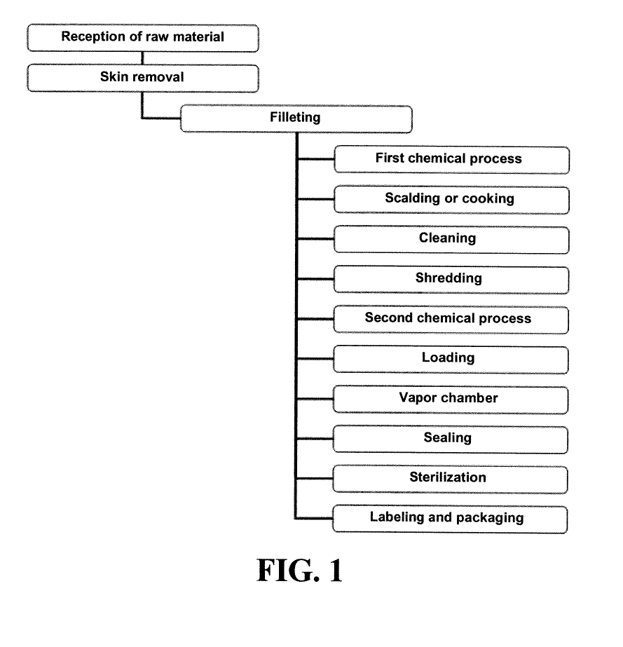

To achieve the advantages and goals of the present development, the following process as shown in FIG. 1 has been implemented, by means of which a substitute is obtained that is similar in taste, color, texture and odor to crab meat.
1. Reception of raw material: shark meat is received on land with an HG cut, in which the shark is headless, tailless and eviscerated. This meat can be fresh, ice-fresh or frozen. The transport to a process plant must be done under refrigeration. Afterwards, the meat is placed in a receptacle or container with drinking-water ice by a maximum period of 48 hours.
2. Skin removal: the shark skin is removed by mechanical or automated means.
3. Filleting: the HG bodies, i.e. headless, tailless and eviscerated, must be filleted by trained personnel, removing the skin and cartilaginous tissues. Then, shark meat is cut into fillets with a thickness from 2 to 10 centimeters. Fillets are collected in receiving trays.
4. First enzymatic chemical process: a solution is prepared with a mixture of food-grade chemical additives in a container with drinkable water. Fillets are immersed in this solution from 30 to 90 minutes. In this stage, the ammonia residue is precipitated. The additives used in this stage are food-grade additives and are listed in Table 1.
5.

TABLE 1
Additives for the first chemical process

| Additive | Percentage |
|---|---|
| Citric acid | 0.01% to 2% |
| Monosodium glutamate | 0.01% to 2% |
| Sodium chloride | 0.5% to 10% |
| Potassium chloride | 0.5% to 10% |

6. Chemical scalding: fillets are placed in a metal container having an adjustable lid with a mixture of food-grade additives and drinking water, and kept at a temperature from 70 to 95° C. for 10 to 60 minutes. In this stage, water is removed from the tissues, which gives the meat a texture similar to the muscular tissues of crabs. The additives used in this stage are food-grade additives and are listed in Table 2.

TABLE 2
Additives for chemical scalding

| Additive | Percentage |
|---|---|
| Sodium chloride | 1% to 10% |
| Citric acid | 0.01% to 2% |
| Monosodium glutamate | 0.01% to 2% |

7. Cleaning: By using manual or automatic methods, dark meat residues are removed and crab-like white meat is conserved.
8. Shredding: white meat or clean fillets are pressed into little segments, causing mass reduction, which are similar to shredded crab meat.
9. Second enzymatic chemical process: shredded meat is immersed in a solution of a mixture of food-grade additives and drinking water at room temperature for 10 to 60 minutes. In this stage ammonia residues remains and pigmenting fluids are removed, and then water is removed and drained. The additives used in this stage are food-grade additives and are listed in Table 3.

TABLE 3
Additives for the second chemical process

| Additive | Percentage |
|---|---|
| Anhydrous citric acid | 0.01% to 2% |
| Monosodium glutamate | 0.01% to 2% |
| Sodium chloride | 0.5% to 10% |
| Potassium chloride | 0.5% to 10% |

10. Loading: shredded meat is placed into metallic or glass containers for preserved food with a defined shape for different volumes and weights, with a loading weight from 80 to 3,000 grams depending on the container, comprising ideally 6 to 51 ounces of drained product. A liquid comprising food-grade additives that are listed in Table 4 is added to this meat-loaded container.

TABLE 4
Additives for the liquid inside the container.

| Additive | Percentage |
|---|---|
| Sodium | 0.01% to 0.5% |
| ethylenediaminetetraacetate | |
| Sodium metabisulfite | 0.01% to 0.3% |
| Monosodium glutamate | 0.01% to 4% |
| Sodium tripolyphosphate | 0.05% to 3% |
| Anhydrous citric acid | 0.005% to 0.5% |
| Sodium chloride | 0.5% to 4% |

11. Vapor chamber: the metallic containers for preserved food with a defined shape are placed into a vapor chamber to remove the oxygen and create vacuum inside said containers.
12. Sealing: the metallic containers for preserved food with a defined shape are sealed in a special machine once removed from the vapor chamber.
13. Sterilization: the sealed containers for preserved food are introduced into an autoclave and subjected to a thermal treatment from 100 to 130° C. for 20 to 60 minutes.
14. Labeling and packaging: the containers for preserved food previously sterilized are labeled, packaged and stored.

The present development has been described with reference to preferred embodiments. Those of ordinary skill in the art will recognize that modifications and alterations to the preferred embodiments are possible. The disclosed preferred embodiments are not intended to limit the scope of the following claims, which are to be construed as broadly as possible, whether literally or according to the doctrine of equivalents.

1. Process to obtain a crab meat substitute from shark—prionace glauca—meat wherein a product is obtained having quality, taste, odor, color and appearance similar to crab meat.

2. Process to obtain a crab meat substitute according to claim 1 wherein the physical and chemical processing applied to shark—prionace glauca—meat are optimal according to its physical characteristics.

3. Process to obtain a crab meat substitute according to claim 2 wherein shark—prionace glauca—meat is received without organs that are not included in the manufacturing process, such as head, tail and entrails.

4. Process to obtain a crab meat substitute according to claim 3 wherein the received shark—prionace glauca—meat parts are transported under refrigeration.

5. Process to obtain a crab meat substitute according to claim 2 wherein skin removal is performed by manual and/or mechanical and/or semiautomatic and/or automatic means.

6. Process to obtain a crab meat substitute according to claim 2 wherein skin and cartilaginous tissues are removed from shark meat and said shark meat is cut in fillets with a thickness of 2 to 10 centimeters.

7. Process to obtain a crab meat substitute according to claim 2 wherein the fillets are subjected to a first enzymatic chemical process wherein a solution of a mixture of food-grade chemical additives is prepared in a container with drinking water at room temperature.

8. Process to obtain a crab meat substitute according to claim 7 wherein the fillets are immersed for 30 to 90 minutes to achieve precipitation of ammonia residues.

9. Process to obtain a crab meat substitute according to claim 7 wherein the additives used in the first enzymatic chemical process comprise food-grade additives.

10. Process to obtain a crab meat substitute according to claim 9 wherein the additives and their composition percentage in the solution comprise the following:
0.1% to 2% citric acid
1% to 2% monosodium glutamate
0.1% to 2% sodium tripolyphosphate
1% to 10% sodium chloride
1% to 10 potassium chloride.

11. Process to obtain a crab meat substitute according to claim 2 wherein fillets are placed into a metallic container having an adjustable lid with a solution comprising food-grade additives and drinking water to perform a chemical scalding at 70 to 95° C. for 10 to 60 minutes to remove water from the tissues and achieve a texture in shark meat similar to muscular tissues of crab meat.

12. Process to obtain a crab meat substitute according to claim 11 wherein the food-grade additives and their composition percentage in the solution comprise the following:
1% sodium chloride.
0.002% sodium metabisulfite.
0.1% to 2% citric acid.
0.1% to 2% monosodium glutamate.

13. Process to obtain a crab meat substitute according to claim 2 wherein dark meat is removed from shark meat by manual and/or mechanical and/or semiautomatic and/or automatic means to obtain white meat similar to crab meat.

14. Process to obtain a crab meat substitute according to claim 2 wherein the white meat is pressed into little pieces similar to crab meat, causing mass reduction.

15. Process to obtain a crab meat substitute according to claim 10 wherein shredded meat is subjected to a second enzymatic chemical process wherein a solution of a mixture of food-grade chemical additives is prepared in a container with drinking water at room temperature.

16. Process to obtain a crab meat substitute according to claim 15 wherein the fillets are immersed for 30 to 90 minutes to achieve removal of ammonia residues and pigmenting fluids.

17. Process to obtain a crab meat substitute according to claim 15 wherein the additives used in the second enzymatic chemical process are food-grade additives.

18. Process to obtain a crab meat substitute according to claim 17 wherein the additives and their composition percentage in the solution comprise the following:
0.1% to 2% anhydrous citric acid.
0.1% to 2% monosodium glutamate.
1% to 10% sodium chloride.
1% to 10% potassium chloride.

19. Process to obtain a crab meat substitute according to claim 2 wherein shredded meat is placed into metallic or glass containers with a defined shape to achieve meat preservation with the addition of food-grade additives.

20. Process to obtain a crab meat substitute according to claim 19 wherein the containers for meat preservation have a loading weight from 80 to 3,000 grams, comprising from 6 to 51 ounces of drained product.

21. Process to obtain a crab meat substitute according to claim 19 wherein the additives and their composition percentage in the solution comprise the following:
0.01% to 0.3% sodium ehtylenediaminetetraacetate.
0.01% to 0.3% sodium metabisulfite.
0.1% to 4% monosodium glutamate.
0.005% to 2% sodium tripolyphosphate.
0.005% to 0.3% anhydrous citric acid.
1% to 4% sodium chloride.

22. Process to obtain a crab meat substitute according to claim 20 wherein the containers for meat preservation are introduced into a vapor chamber to remove the oxygen and create vacuum.

23. Process to obtain a crab meat substitute according to claim 22 wherein the containers for meat preservation are sealed in a special machine once removed from the vapor chamber.

24. Process to obtain a crab meat substitute according to claim 23 wherein the sealed containers for meat preservation are introduced into an autoclave to subject them to a thermal treatment at 100 to 130° C. for 20 to 120 minutes, to achieve complete sterilization.

25. Process to obtain a crab meat substitute according to claim 24 wherein the sealed and sterilized containers for meat preservation are labeled, packaged and stored for commercialization.
